(19) United States
(12) Patent Application Publication
(10) Pub. No.: US 2008/0131567 A1
(43) Pub. Date: Jun. 5, 2008

(54) VACUUM SEALABLE COFFEE AND MARINATING FOOD STORAGE CONTAINER

(76) Inventor: Anthony R. Lemme, Wallingford, CT (US)

Correspondence Address: LAW OFFICE OF DELIO & PETERSON, LLC., 121 WHITNEY AVENUE, 3RD FLLOR, NEW HAVEN, CT, 06510, US

(21) Appl. No.: 11/684,206

(22) Filed: Mar. 9, 2007

Related U.S. Application Data
(63) Continuation-in-part of application No. 10/605,468, filed on Oct. 1, 2003, now Pat. No. 7,198,074.

(51) Int. Cl. B65D 81/24; A23L 3/015; B08B 7/00

(52) U.S. Cl. 426/418; 134/42; 29/428; 426/442; 99/468; 99/472

(57) ABSTRACT

A vacuum food storage device having a container, a lid, a pump to evacuate air, a switch engageable by contact of the pump to the lid, or by contact of the lid to the container, to permit the pump to evacuate air from the container to a desire degree of vacuum. A sensor disengages the pump when a desired vacuum is achieved, and a timer disengages the pump after a predetermined time. Upon placing the pump on the lid, or the lid on the container, engaging the switch, and operating the pump, the pump is disengaged at the earlier of: i) achieving a desired vacuum in the container, or ii) expiration of the predetermined time. The container may also be used to marinate food, wherein upon evacuating air the base is simultaneously raised to move the food with respect to the marinade.

### RELATED APPLICATIONS

The subject matter of this application is related to that disclosed and claimed in U.S. application Ser. No. [ATTY DOCKET NO. EIC 120001000] entitled “Motorized Vacuum/Pressure Marinating Food and Storage Container” by the same inventor filed on even date herewith, which is a continuation-in-part of pending U.S. application Ser. No. 10/605,468 filed on Oct. 1, 2003.

### BACKGROUND OF THE INVENTION

1. Field of the Invention

This invention relates to a food storage container which may be used for storing or marinating food under vacuum or pressure and, in particular, to a container having a motorized vacuum/pressure pump incorporated into the container lid and a method for making and using the container.

2. Description of Related Art

Vacuum food storage containers may be used for storage of foods such as coffee to preserve freshness, and to infuse marinade into foods. U.S. patent application Ser. No. 10/605,468 discloses a container having a vacuum/pressure pump in the container lid. The container is used for storing food or drinks, or for marinating foods. The present invention describes improvements to the container and lid of U.S. patent application Ser. No. 10/605,468, the disclosure of which is hereby incorporated by reference.

### SUMMARY OF THE INVENTION

It is an object of the present invention to provide a vacuum or pressure food storage device that filters air entering or leaving the container.

It is another object of the present invention to provide a vacuum or pressure food storage device that protects the pump motor and power supply from excessive use in the case of an air leak in the container.

A further object of the invention is to provide a vacuum or pressure food storage container having a pressure or vacuum indicator that permits calibration of the pressure or vacuum sensor prior to or during assembly into the container.

It is yet another object of the present invention to provide a vacuum or pressure food storage device that incorporates the vacuum or pressure pump in the container lid and permits removal of the pump prior to cleaning the lid.

A further object of the invention is to provide a vacuum or pressure food storage container having a two stage seal that permits better hermetic sealing of the lid to the container.

It is another object of the present invention to provide a vacuum food marinating method and device that moves the food with respect to the marinade while evacuating air from the container.

It is another object of the present invention to provide a vacuum food marinating method and device that allows deeper saturation of marinade into the foods.

Still other objects and advantages of the invention will in part be obvious and will in part be apparent from the specification.

The above and other objects, which will be apparent to those skilled in the art, are achieved in the present invention which is directed to a method of marinating food. The method includes providing a container for the food, the container having a pump for pressurizing air into or evacuating air from the container and a controller. The controller is adapted to control the degree of pressure or vacuum to be achieved in the container, the time for which the pressure or vacuum is maintained, the admission of air into or evacuation of air out of the container, and the time for which the air admission or evacuation is maintained. The method additionally includes providing a marinade in the container and hermetically sealing the food in the container in contact with the marinade. Using the controller, air is repeatedly pressurized into or evacuated from the container to a desired degree of pressure or vacuum while maintaining the food in contact with the marinade under the pressure or vacuum for a desired time. The hermetic seal is then released to permit air to enter or leave the container. The food is maintained in contact with the marinade and the pressurized air or vacuum in the container for a desired time in accordance with a desired control program.

The controller may be used to repeatedly evacuate air from the container to a desired degree of vacuum, maintain the food in contact with the marinade under the vacuum for a desired time, release the hermetic seal to permit air to enter the container and maintain the food in contact with the marinade and the air in the container for a desired time, in accordance with a desired control program.

The food may be disposed on the base of the container when in contact with the marinade, whereby the base of the container is raised during evacuation of the container to move the food with respect to the marinade. The container is preferably provided with a flexible base. Evacuating air from the container causes the base to rise as a result of pressure differential between the vacuum in the container and atmospheric air pressure outside the container.

The controller may have a selection of control programs for different degrees of vacuum to be achieved in the container, times for which the vacuum is maintained, amount of air to be admitted into the container, and/or times for which the air admission is maintained, and the method may include selecting the desired control program prior to use the controller.

In another aspect the invention is directed to a method of marinating food which comprises providing a container for the food, providing a marinade in the container, hermetically sealing the food in the container on a base in contact with the marinade and evacuating air from the container to a desired degree of vacuum while simultaneously raising the base of the container to move the food with respect to the marinade. In this method food is maintained in contact with the marinade under the vacuum for a desired time. The hermetic seal is then released to permit air to enter the container while simultaneously lowering the base of the container when the food has been marinated to a desired degree.

The container may be provided with a flexible base, wherein evacuating air from the container causes the base to raise as a result of pressure differential between the vacuum in the container and atmospheric air pressure outside the container, and wherein releasing the hermetic seal to permit air to enter the container causes the base to lower.

Another aspect of the invention provides a method of storing food under a vacuum comprising providing a container for the food, the container having a filter for entry and exit of air into and out of the container, and hermetically sealing the food in the container. The method then includes evacuating air from the container to a desired degree of vacuum while simultaneously filtering air evacuated Out of the container through the filter, maintaining the food under the vacuum for a desired time, and releasing the hermetic seal to permit air to enter the container while simultaneously filtering air entering into the container through the filter.

There may be food particles may be trapped in the filter during evacuation of the air from the container, so that at least a portion of the food particles trapped in the filter may be expelled from the filter during entry of the air into the container.

In a related aspect the invention provides a vacuum food storage device having a container for storing food that is hermetically sealable and has a filter for entry and exit of air into and out of the container. The filter may be adapted to filter air evacuated out of the container and air entering into the container.

The filter of the vacuum food storage device may trap food particles in the filter during evacuation of the air from the container, and expel at least a portion of the food particles trapped in the filter during entry of the air into the container.

A further aspect of the invention is directed to a method of storing food under a vacuum which includes providing a container for the food with a lid to hermetically seal food in the container, a pump to evacuate air from the container and a switch engageable by contact of the pump to the lid, or by contact of the lid to the container, to permit operation of the pump to evacuate air from the container to a desire degree of vacuum. The method also includes providing a sensor to disengage operation of the pump when a desired degree of vacuum is achieved in the container and a timer to disengage operation of the pump after a predetermined time. The food is then placed in the container and the pump placed on the lid or the lid on the container, which engages the switch. The pump is operated to evacuate air from the container and the operation of the pump is disengaged after a desired degree of vacuum in the container is achieved or a predetermined time expires by the timer, whichever is earlier.

In a related aspect the invention provides a vacuum food storage device having a container for the food, a lid to hermetically seal food in the container, a pump to evacuate air from the container, a switch engageable by contact of the pump to the lid, or by contact of the lid to the container, to permit operation of the pump to evacuate air from the container to a desire degree of vacuum, a sensor to disengage operation of the pump when a desired degree of vacuum is achieved in the container, and a timer to disengage operation of the pump after a predetermined time. Upon placing the pump on the lid, or the lid on the container, engaging the switch, and operating the pump to evacuate air from the container operation of the pump is disengaged at the earlier of: i) achieving a desired degree of vacuum in the container, or ii) expiration of the predetermined time by the tinter.

The pump may be disposed in the lid and the switch may be adapted to commence operation of the pump upon contact of the lid with the container. Alternatively, the pump may be separate from the lid and the switch may be adapted to commence operation of the pump upon contact of the pump with the lid.

Yet another aspect of the invention provides a method of making a vacuum or pressure food storage device by providing a container for the food, a lid to hermetically seal food in the container, and a pump to evacuate air from the container. Separately from the container a sensor is provided to disengage operation of the pump when a desired degree of vacuum or pressure is achieved in the container. The sensor may be calibrated and set, separately from the container, with a predetermined degree of vacuum or pressure required to disengage operation of the pump The sensor in the container may be installed during manufacture to establish the predetermined degree of vacuum or pressure at which operation of the pump is disengaged. The pump may be disposed in the lid and the sensor may be installed during manufacture of the container.

In a related aspect, the invention is directed to a vacuum or pressure food storage device comprising a container for the food, a lid to hermetically seal food in the container, a pump to evacuate air from the container, and a sensor to disengage operation of the pump when a desired degree of vacuum or pressure is achieved in the container. The sensor is separable from the container to calibrate and set the degree of vacuum or pressure required to disengage operation of the pump. The sensor may be calibrated to a predetermined degree of vacuum or pressure apart from the container, and installed in the container during manufacture thereof to establish the predetermined degree of vacuum or pressure at which operation of the pump is disengaged. The pump may be disposed in the lid and the sensor may be installed during manufacture of the container.

The sensor may comprise a flexible membrane with an electrically conductive first contact secured thereto, and an electrically conductive second contact adjustably spaced from the first contact.

A further aspect of the invention is directed to a method of hermetically sealing a vacuum food storage device comprising providing a container for the food, wherein the container has a lip around an opening therein. The lip has a first portion extending outwardly with respect to the container opening and a second portion extending upwardly and inwardly with respect to the container opening. The method also includes providing a lid securable to the container opening to hermetically seal food in the container. The lid includes a seal having a first portion tightly engageable with the lip first portion when the lid is secured to the container opening to create an initial, partially airtight seal, and a second portion engageable with the lip second portion to create a hermetic seal as air is evacuated from the container. The method includes securing the lid to the container lip and tightly engaging the first portion of the lid seal with the container lip first portion to create an initial seal, and evacuating air from the container to cause the second portion of the lid seal to engage with the container lip second portion to create a hermetic seal between the lid and the container.

Upon securing the lid to the container lip and prior to evacuating air from the container, the second portion of the lid may not be hermetically sealed to the container lip second portion.

A related aspect of the invention provides a vacuum food storage device comprising a container for the food having a lip around an opening therein, wherein the lip has a first portion extending outwardly with respect to the container opening and a second portion extending upwardly and inwardly with respect to the container opening. The device includes a lid securable to the container opening to hermetically seal food in the container, wherein the lid includes a seal having a first portion tightly engageable with the lip first portion when the lid is secured to the container opening to create an initial seal, and a second portion engageable with the with the lip second portion to create a hermetic seal as air is evacuated from the container.

In another aspect the present invention is directed to a method of cleaning a vacuum or pressure food storage device comprising providing a container for the food, a lid to hermetically seal food in the container, an opening in an exterior surface of the lid for receiving a pump, and a vacuum or pressure pump to evacuate air from or inject air into the container. The pump is releasably mounted in the pump opening in the lid by a latch. The method includes operating the latch and removing the pump from the lid, cleaning the lid, and thereafter reattaching the pump to the lid opening using the latch.

A related aspect provides a vacuum or pressure food storage device comprising a container for the food, a lid to hermetically seal food in the container, an opening in an exterior surface of the lid for receiving a pump, and a vacuum or pressure pump to evacuate air from or inject air into the container. The pump is releasably mounted in the pump opening in the lid by a latch, whereby the pump may be removed by hand by a user from the pump opening prior to cleaning the lid.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a cross-sectional elevational view of one embodiment of the vacuum/pressure food storage container and lid of the present invention.

FIG. 2 is a top plan view of the lid of FIG. 1 showing location of the pump.

FIG. 3 is across-sectional view of the preferred pump of FIG. 2.

FIG. 4 is a cross-sectional view of the preferred piston and piston drive portion of the pump of FIG. 2.

FIG. 5 is an elevational view of the interior of the piston drive chamber of FIG. 4, as it would be if unwrapped.

FIG. 6 is a top plan view of the preferred one-way valve diaphragms used with the present invention.

FIG. 7 is a side, cross-sectional, elevational view of the preferred one-way valve used in the present invention, employing one embodiment of the diaphragm of FIG. 6.

FIG. 8 is a side, cross-sectional, elevational view of the preferred one-way valve used in the present invention, employing another embodiment of the diaphragm of FIG. 6.

FIG. 9 is an enlargement, partially in cross-section and partially in schematic form, of one embodiment of the vacuum/pressure limit indicator employed in the lid of FIG. 1.

FIG. 10 is a cross-sectional elevational view of another embodiment of the vacuum/pressure food storage container and lid of the present invention, showing the flexing of the container base and food during evacuation of the container.

FIG. 10a is a cross-sectional elevational view of an alternate base configuration for the container shown in FIG. 10.

FIG. 11 is a cross-sectional elevational view of the removable vacuum/pressure limit indicator employed in the lid of FIG. 10, showing adjustment of the sensor contacts.

FIG. 12 is a cross-sectional elevational view of the vacuum/pressure limit indicator of FIG. 11, showing movement of the sensor contacts.

FIG. 13 is cross-sectional elevational view of the filter mechanism employed in the lid of FIG. 10.

FIG. 14 is cross-sectional elevational view of the container lid seal and contact switch employed in the lid of FIG. 10.

FIG. 15 is an enlarged view of the lid seal of FIG. 14.

FIG. 16 is a side elevational view showing a further embodiment of the vacuum/pressure food storage container and lid of the present invention, wherein the pump is removable from the remainder of the lid.

FIG. 17 is an end elevational view of the container and lid of FIG. 16.

FIG. 18 is a top plan view of the container and lid of FIG. 16.

### DESCRIPTION OF THE PREFERRED EMBODIMENT(S)

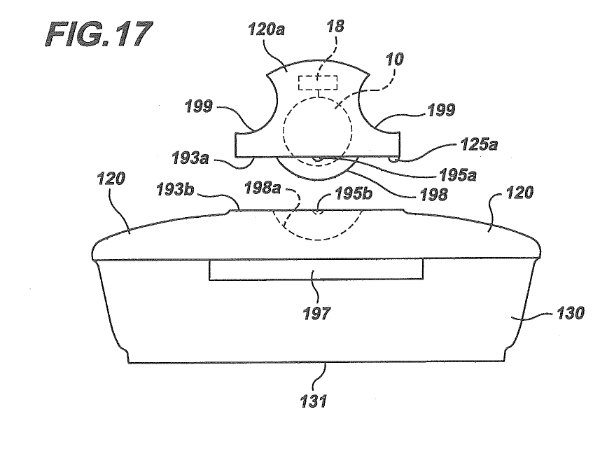

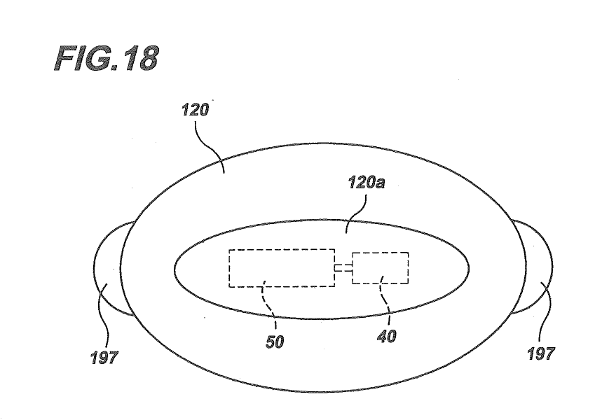

In describing the preferred embodiment of the present invention, reference will be made herein to FIGS. 1-18 of the drawings in which like numerals refer to like features of the invention.

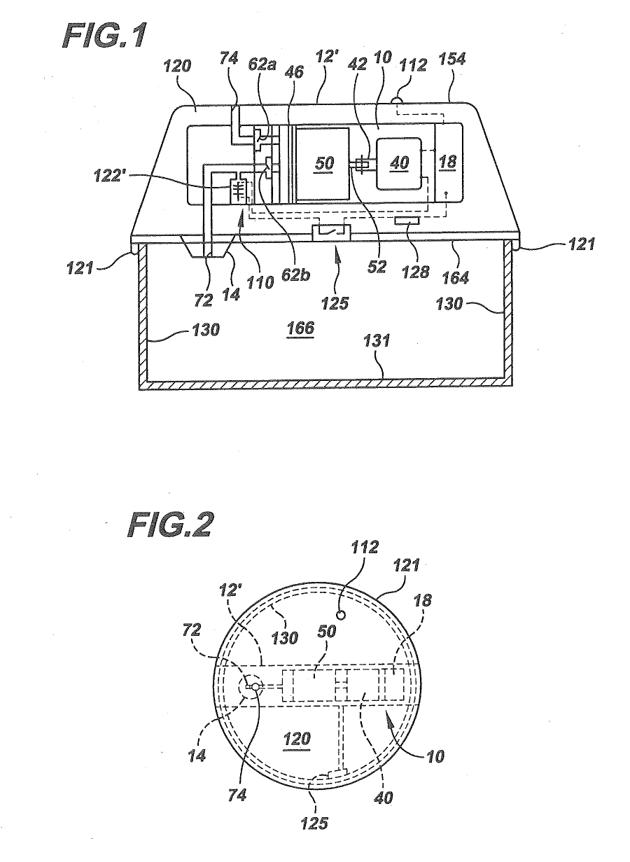

In FIGS. 1 and 2 there is depicted the pump of the present invention, configured in the vacuum-pumping mode, in combination with a lid of a food or drink container. Flat, circular lid 120 attaches by a lip 121 at its periphery, by snap fit, to hermetically seal the open neck of a container 130, such as a typical one-pound cylindrical coffee can, or a custom mating container. Pump 10 is shown employed in a vacuum mode, and is disposed in a horizontal configuration so that the pump housing serves as a handle to attach and remove the lid. While any air pump and one-way valve may be employed with the present invention, the operation of the preferred pump, including battery pack 18, motor 40, output shaft 42, rotating member 52, reciprocating member 50, piston seals 46, one-way valves 62a, 62b and atmospheric vent 74 will be described further below. Passageway 72 communicates through conical head 14 with the lower side of lid 120 to permit air or other fluid to be pumped out of the interior of container 130. An electrical switch 125 is provided adjacent to the periphery of lid 120, and is movable between a biased open position when the lid is off the container, and a closed position when lid 120 is placed on the container. An electrical circuit is provided connecting battery pack IS, motor 40 and vacuum indicator 110. The contact moved by membrane 122′ is in the normally closed position at atmospheric pressure, and is opened when the pressure in passageway 72 (and the interior of container 130) reaches a desired degree of vacuum, at which time the contacts open.

When the lid is snapped onto a container at normal atmospheric pressure, switch 125 is closed and, because the switch contacts of indicator 110 are also closed, the circuit is closed, motor 40 is energized by battery 18, and pump 10 commences removing the air from the interior of container 130. When the predetermined degree of vacuum is achieved, membrane 122′ moves to open the contacts of indicator 110, and open the circuit, shutting off the vacuum pump. An indicator light 112, operatively energized by the opening of the contacts of indicator 110, may signal to the user that the predetermined degree of vacuum is achieved. Since the atmospheric pressure outside the container is higher than the pressure inside the container., one way valves 62a,62b are sealed closed, and air cannot enter the container through the lid. Should the seal between lid 120 and container 130 leak while the lid is in place, or if the container otherwise permits air to enter, the contacts of vacuum indicator 110 will again close and return the contents of the container to the predetermined vacuum level. When lid 120 is removed from the container, switch 125 returns to its normally open position, and the pump cannot operate.

If one-way valves 62a, 62b are reversed, so that the pump operates in the pressure mode, and indicator 110 is calibrated to open at a predetermined level of pressure above atmospheric, the combination lid 120 and pump 10 may be used to maintain the interior of container 130 in a pressurized state above outside atmospheric pressure. In their reversed position, one way valves 62a, 62b are sealed closed because the atmospheric pressure outside the container is lower than the pressure inside the container, and air cannot escape the container through the lid. If air does escape, indicator 110 will close its contacts, and the pump will add more air pressure. Alternatively, in the embodiment of FIGS. 1 and 2, one-way valves 62a, 62b may be mounted in a movable flow control valve as described in U.S. patent application Ser. No. 10/605,468 to provide a switch between vacuum and pressure modes. Lid 120 should be provided with a positive sealing mechanism with container 130, such as a screw or clamp, if used in the pressure mode.

A controller 128, such as a microprocessor, may also be incorporated in the circuit of the lid pump 10 to cycle the pump on and off as desired. This is useful when the container is used for marinating foods.

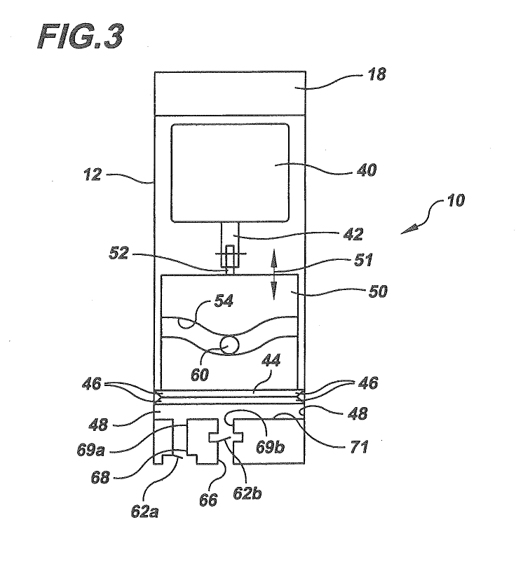

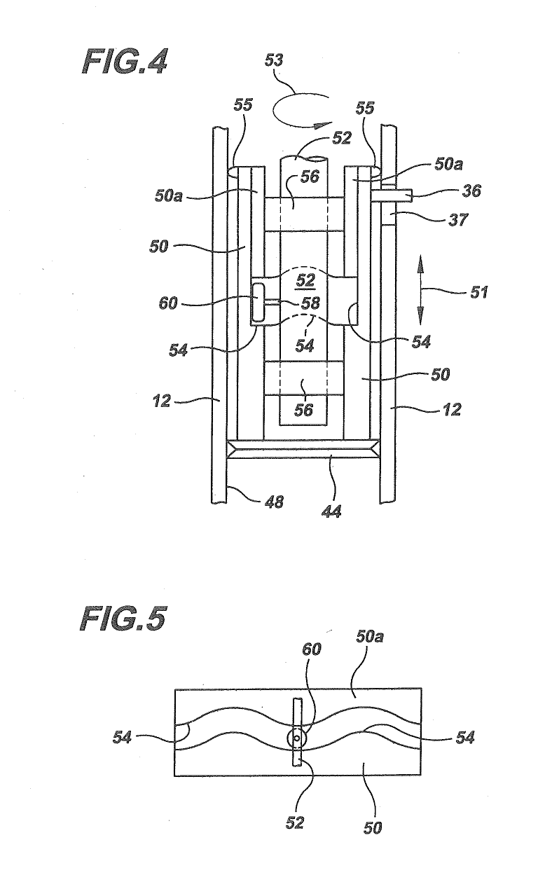

In FIGS. 3 and 4, there is shown the preferred embodiment of the vacuum or pressure pump 10 employed in the present invention. The motorized pump 10 has a generally cylindrical plastic housing 12 which is sized to be easily held by a user's hand. At the upper end thereof, a battery pack 18, holding either rechargeable or non-rechargeable batteries, powers an electrical motor 40 having an output shaft 42 which rotates along an axis generally coaxial with housing 12. Alternatively, the motor may be connected by means of a conventional power cord to a source of AC or DC power. Operatively connected to the output shaft 42 of the motor is a piston drive mechanism, which comprises piston drive rotating member 52 and piston drive reciprocating member 50. Piston drive rotating member 52 is connected to output shaft 42 by a pin or other connector. Piston drive reciprocating member 50 is preferably cylindrical in configuration and coaxial with housing 12, and is connected at its lower end to piston 44 which includes a pair of flexible polymeric seals 46 which mate with and slide along the interior walls of chamber 48 within housing 12 in substantially airtight engagement. Both piston 44 and piston drive reciprocating member 50 are preferably integrally formed as a single unit, as shown, and slide in a reciprocating motion, up and down, within the housing as shown by the direction of arrow 51. The upstroke of the piston and piston drive reciprocating member is generally referred to as the vacuum stroke, and the down stroke of piston and piston and piston drive reciprocating member is generally referred to as the pressure stroke.

The structure of the piston drive mechanism is shown in more detail in FIGS. 4 and 5. Piston drive reciprocating member 50 has a hollow cylindrical body, with an outer diameter slightly smaller than the inner diameter of housing 12 to petit it to reciprocate with piston 44 during the vacuum and pressure strokes in the directions of arrow 51. Piston drive rotating member 52 includes a cylindrical shaft portion extending downward from the motor output shaft within reciprocating member 50, and is held in coaxial orientation therewith by bearings 56 mounted within reciprocating member 50 and 50a, to permit relative rotational movement of rotating member 52. Extending around the interior cylindrical wall of reciprocating member 50 is a track 54, which comprises a groove that is non-linear in configuration. In the preferred embodiment, when the interior wall of reciprocating member 50 is shown in an unwrapped view in FIG. 5, track 54 has a sinusoidal configuration which extends upward and downward as it wraps around the inner periphery of reciprocating member 50. The lower portion of track 54 is formed by a sinusoidally extending ledge within member 50, and the upper portion of the track is formed by the lower, complimentarily formed lip of inner sleeve member 50a, which is keyed and compression fit or welded to member 50.

Received in sliding and/or rolling relationship within track 54 is a wheel 60, which is mounted on an axle 58 extending transversely from the axis of rotating member 52. When rotating member 52 rotates as shown in direction of arrow 53, it is prevented from reciprocal movement in the direction of arrow 51 by its fixed attachment to output shaft 42 of motor 40. As wheel 60 travels within track 54, due to the non-linear, sinusoidal configuration of the track, a reciprocating movement is imparted to piston drive reciprocating member 50 in direction of arrow 51. A pin 36 extending outward from reciprocating member 50 through a vertical slot 37 in the side of housing 12 prevents reciprocating member 50 from rotational movement in direction 53 while permitting reciprocating movement in directions 51. Spacer ring 55 is connected to and extends around the outer periphery of the upper portion of reciprocating member 50 to permit proper alignment during reciprocating movement. This reciprocating movement is imparted to the operatively connected piston 44 to move piston 44 alternately through vacuum and pressure strokes as motor 40 operates to turn output shaft 42 and rotating member 52. Other non-linear configurations of track 54 may be utilized for example, a saw tooth shape, to impart any type of desired reciprocating movement to piston 44. Instead of the groove shown, the track may be a continuous protrusion extending circumferentially around the inside of reciprocating member 50, and the shaft/wheel slidingly captures the protruding track. Moreover, the position of the track and shaft/wheel may be reversed, so that the track is disposed in the outer side wall of rotational member 52 and the shaft and wheel are disposed extending in from reciprocating member 50. Also, a pair of wheels may be employed, for example, in the embodiment of FIG. 4, wherein an additional axle and wheel extend from member 52 to the right, opposite wheel 60, and also engaged with track 54.

The pumping motion of piston 44 may be utilized to operate pump 10 in either pressure or vacuum mode, depending on the direction of one-way valves 62a, 62b (FIGS. 1 and 3). Pump chamber 48 is formed between piston 44, housing 12 walls, and wall 71. Openings 69a, 69b in wall 71 respectively align and permit communication with one-way valves 62a, 62b, disposed in passageways 66, 68. The lower opening of passageway 68 aligns and communicates with passageway 74 (FIG. 1) to atmospheric air surrounding housing 12, and the lower opening of passageway 66 aligns and communicates with passageway 72 (FIG. 1) which connects to the food or drink container 130.

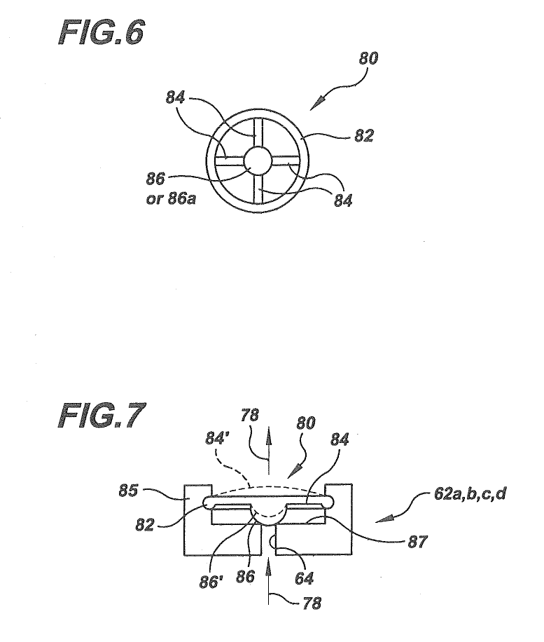

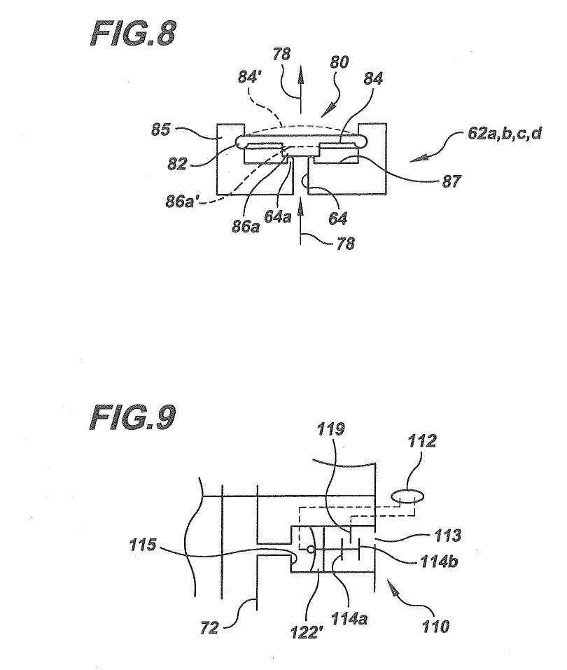

While any known one-way valves 62a, 62b may be utilized, for example the flap valve shown in FIGS. 1 and 3, the preferred one-way valve of the present invention is depicted in FIGS. 6, 7 and 8. As shown in FIG. 6, valve diaphragm 80 is made of a one-piece, unitary, flexible polymer and has either a central sealing bulb member 86 (FIG. 7), or a flat cap member 86a (FIG. 8), each supported by four arms 84 radially extending inward from ring member 82. FIGS. 7 and 8 depict valve diaphragm 80 mounted in any of one-way valves 62a, 62b to permit airflow only in direction 78. Because of the different orientations of the one-way valves in the figures, the relative position of the valve depicted in FIG. 7 would be inverted for those one-way valves in which the permitted airflow direction is downward. Valve diaphragm ring member 82 is disposed in the upstanding cylindrical collar 85 of the one-way valve seat 87, outward of one-way valve seat opening 64, so that anus 84 hold bulb 86 (FIG. 7) or cap 86a (FIG. 8) in normally biased sealing relationship against valve opening 64 in the base of the valve seat. As shown in FIG. 8, when using cap 86a, opening 64 may include an upstanding lip 64a to seal against the lower surface of the cap in the closed position. (Lip 64a may also be used to seal against the lower surface of bulb 86 in that embodiment.) When air is forced upward through passageway 64 in direction 78, or a vacuum is pulled above diaphragm 80 in direction 78, the bulb is drawn upward into position 86′ (FIG. 7), or the cap is drawn upward into position 56a′ (FIG. 8), and the arms flex and stretch upward into position 84′ to open passageway 64 and permit air flow in direction 78. When the airflow is reversed, bulb 86 or cap 86a remains seated in opening 64, and does not permit airflow in the direction opposite to arrow 78.

The preferred embodiment of the storage container lid also employs a vacuum/pressure indicator 110 to signal when the container has reached the proper level of pressure or vacuum. As shown in more detail in FIG. 9, one embodiment of indicator 110 is disposed in a chamber 115 and comprises a flexible membrane 122′ exposed on one side to atmospheric pressure, via a vent opening 113, and on the other side to fluid pressure present in bore 72 and the container interior, via a passageway between chamber 115 and bore 72, as the container being pressurized or evacuated. Membrane 122′ is preferably made from a flexible thermoplastic material of durometer and thickness suitable to move the contacts as described, when exposed to the desired pressure or vacuum limit. Flexible membrane 122′ extending across chamber 115 has a curved inner surface to increase the amount of surface area exposed to the pressure differential present in chamber 115, and a pair of movable electrical contacts 114a, 114b connected thereto. Electrical contact 119 is contacted by movable vacuum contact 114b when the bore pressure falls to a predetermined degree of vacuum, and is contacted by movable pressure contact 114a when the bore pressure rises to a predetermined degree of over pressure. If either event occurs, the circuit is completed to energize signal light 112. Alternatively, signal 112 may be a sounding device that emits a noise when energized. The position of contact 119 may be fixed or may be adjustable for calibration purposes.

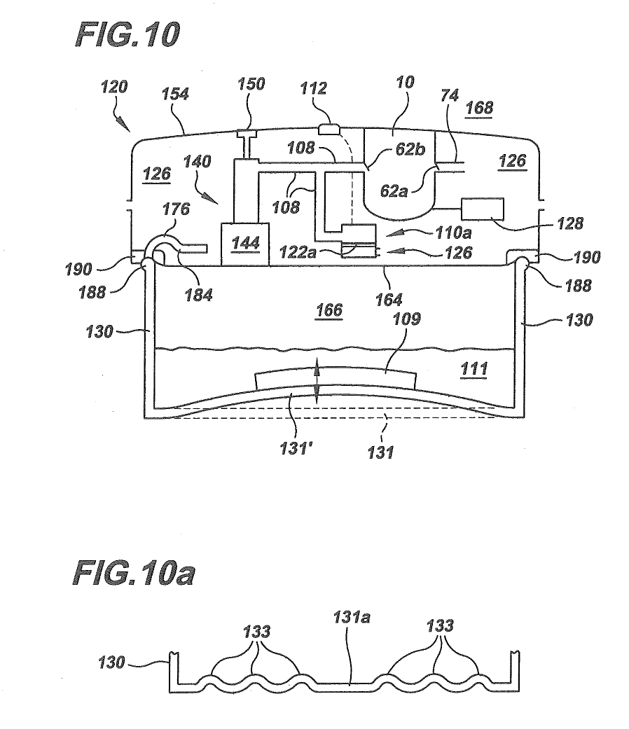

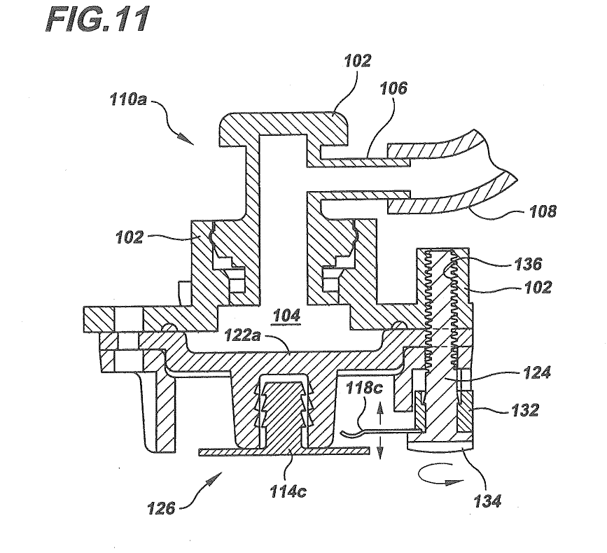

Another embodiment of the vacuum/pressure food storage container and lid of the present invention is shown in FIG. 10. Lid 120 again includes pump 10 and one-way valves 62a and 62b shown in the vacuum pumping mode. (Reversal of the direction of valves 62a, 62b would cause the pump to operate in the pressure mode, as explained previously.) Pump 10 is connected by tubing 108 to the container interior via filter 144 and to a vacuum indicator and sensor 110a. Both the filter and vacuum indicator will be explained in further detail below. Air is expelled from pump 10 through one-way valve 62a and passageway 74 either directly to the lid exterior or to the lid upper interior section 126 which is vented to the atmosphere 168 as shown. The lid underside 164 and circumferential seal 190 hermetically seal the lid over the container lip or rim 188. A preferred lid contact lever 176 extending through a portion of seal 190 is used as the lid contact sensor (125 in FIG. 1), and both the seal and contact lever will also be explained in further detail below.

Container 130 preferably has a flexible base 131, which is movable by pressure differential between normal position 131 when the interior 166 of the container is at the same pressure as the outside 168 atmospheric pressure, and a flexed position 131′ when the pressure inside the container is lower than the outside pressure. Upon hermetically sealing lid 120 over the open top of container 130, the pump 10 may be operated to draw air out of the container until a desired degree of vacuum is achieved, thereby flexing container base 131 upward. In so flexing, food 109 immersed in a marinade 111 provided within container 130 may be moved and stretched by the base 131′, which is drawn inward and upward, so as to expand the area of the food surface exposed to the marinade, or at least move it with respect to the marinade. Upon releasing the hermetic seal or otherwise permitting air to re-enter the container, the base returns to its original position 131 and again moves the food with respect to the surrounding marinade.

While base 131 is substantially flat in FIG. 10, the base may also be formed with an accordion-like structure as seen in cross-section in FIG. 10a, where flexible base 131a has undulations 133 that form a concentric ring pattern when seen in plan view (not shown). Such undulations are believed to assist in flexing the base upward and moving the food therein as the air is evacuated from the container. The thickness of the base may be substantially constant or may vary at different portions of the undulations. Container 130 is preferably made of a thermoplastic polymer, and the composition and thickness of the container walls (including the container bottom 131 or 131a) may be determined without undue experimentation.

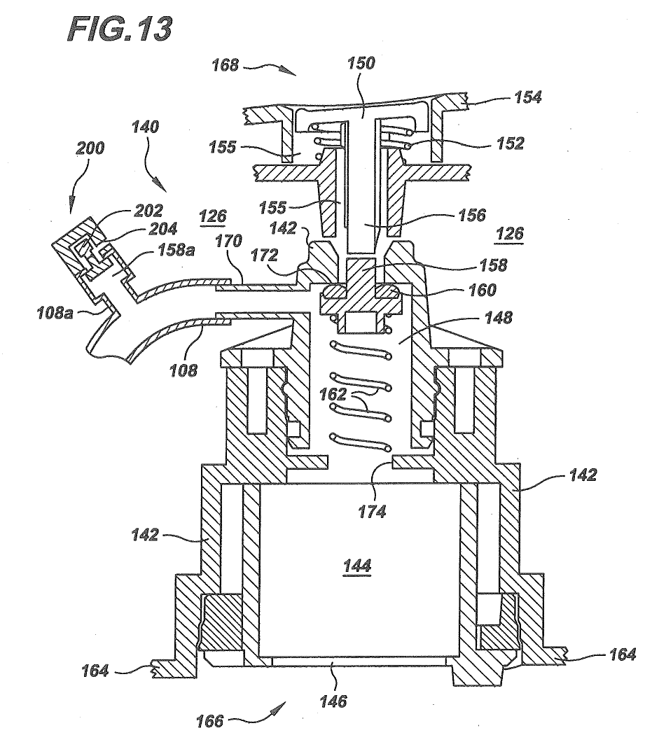

Controller 128, which controls the operation of pump 10, may also be made to cause and control the reentry of air into the container. This is done by employing an actuator operable by the controller, such as a solenoid, to open a valve in a passageway between the container interior and the external atmospheric pressure, to permit re-entry of air into the container. An electrically operated actuator 150 or 200 (FIG. 13) may be employed in this manner, as will be discussed further below. As mentioned above, the pump may be cycled on and off by the controller during the marinating of foods. In a preferred embodiment, after the food and marinade are placed in the container, the lid is hermetically sealed over the container. Following input from a user, either by a selecting from a choice of a preprogrammed default cycle or different pre-programmed vacuum cycling operations, or by manually selecting a cycling operation, the controller causes the pump to evacuate air from the container to a desired degree of vacuum, and maintain the vacuum for a desired time while the food is in contact with the marinade. After the food has been marinated under vacuum for the desired time period, the controller releases the hermetic seal to permit air to enter the container, and maintains the new pressure (which may be at atmospheric pressure or at a lower vacuum than initially created) for a desired time period, so that the food is in contact with the marinade at a higher pressure than before. After the desired time at the higher pressure is passed, the controller then again causes the pump to evacuate air from the container to the desired vacuum level and for the desired time period. This cycling of different pressures to which the food and marinade are exposed may be repeated as desired by the control program selected or inputted by the user to improve the efficiency of the marinating. With the flexible base as shown in FIG. 10, this cycling of pressure also causes movement of the food with respect to the marinade, resulting in faster and better infusion and saturation of the marinade into the food. It is believed that air and/or liquids are removed from the foods during the vacuum cycles, and are replaced by marinade liquid during re-pressurization. It is also believed that flexing movement of food such as meat between the different vacuum/pressure cycles also contributes to tenderizing of the food. The same cycling may be used at pressurized conditions above atmospheric pressure to marinate the food in the container.

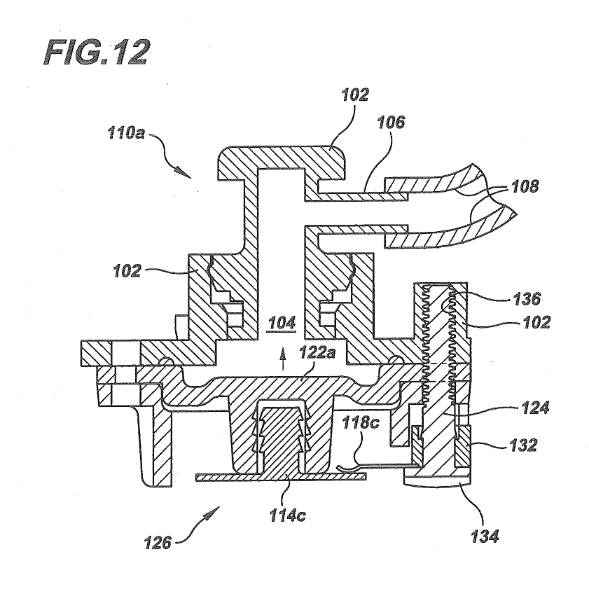

A preferred embodiment of the vacuum indicator switch is shown in FIGS. 11 and 12. Indicator switch 110a has a housing 102 that is securable in the container lid and includes attachment flange 106 that leads to a central interior chamber 104 within the housing. Flexible membrane or diaphragm 122a seals the lower portion of chamber 104, and is movable upward (FIG. 12) in response to a degree of vacuum in chamber 104 with respect to atmospheric pressure in region 126 on the opposite side of the membrane. Tube 108 may be slidingly secured to flange 106 to connect to the container interior, which is subject to the vacuum conditions. In a preferred embodiment, tube 108 connects in a “T” connection to the tube between the vacuum pump 10 and the container interior 166. A metal electrical contact 114c has a barbed plug portion secured upward in a corresponding opening in the lower portion of membrane 122a, so that the contact moves up and down with the membrane movement. The outwardly extending arms of contact 114c move between a position spaced from electrical spring contact 118c when the degree of vacuum inside the container is insufficient (FIG. 11) to a position in electrical contact with metal spring contact 118c when the desired degree of vacuum is achieved inside the container (FIG. 12). Contacts 114c and 118c are electrically connected to a circuit so that the circuit closes and shuts off the vacuum pump when the contacts 114c and 120 contact each other.

To calibrate the indicator switch to electrically signal the desired degree of vacuum, indicator switch 110a includes an adjustable positioning mechanism for spring contact 118c. Threaded screw 124 is received into comparably threaded opening 136 in housing 102, and includes a non-threaded barrel portion around which is slidingly mounted elevator 132 to which spring contact 118c is fixed at one end. As screw 124 is rotated by engaging screw head 134 with a screwdriver, elevator 132 slides without rotation to move spring contact 118c up or down as indicated by the arrows in FIG. 11. Indicator 110a may be calibrated separately from the container lid by mounting it in a test facility (not shown) and connecting tube 108 to a vacuum source while exposing area 126 to atmospheric pressure. When the desired degree of vacuum is achieved in the vacuum source, screw 124 is adjusted so that spring contact 118c just makes contact with the arm of contact 114c. Indicator 110a is then removed from the test facility and installed in the container lid, with the desired vacuum calibration.

Indicator 110a may also be used for indicating above-atmospheric pressure by locating spring contact 118c on the other side of the arm of contact 114c, below, so that when membrane 122a moves downward due to overpressure in chamber 104, the contacts 114c and 118c make electrical contact at the desired pressure above atmospheric.

A filter to clean air entering and leaving the container interior 166 is shown in FIG. 13. Filter and vacuum release mechanism 140 has housing 142 disposed between lid top 154 and lid bottom 164. At the lower end of housing 142 a filter of desired porosity is secured between lower mesh screen 146 and housing interior chamber 148. Housing 142 includes attachment flange 170 which receives tube 108 to connect the vacuum pump 10 to chamber 148. When air is evacuated from the container by the vacuum pump, it travels from the container interior through mesh screen 146, through filter 144, through chamber 148 and out through tube 108. In doing so, spattered food particles, including drops from the marinade or other liquid in the container, are trapped by the mesh screen and filter, so that they do not damage the pump.

Mechanism 140 also includes a release actuator 150 mounted in lid upper surface 154 to permit the vacuum to be released from the container. Release actuator 150 is urged by coiled spring 152, mounted in lid opening 155 around the button body, upward away from valve 158. Valve 158 is urged by coiled spring 162, mounted on interior housing shoulder 174 in the lower end of chamber 148, upward against shoulder 172 in the upper end of chamber 148. A flexible seal 160 around valve 158 ensures that no air enters the upper end of the chamber when the valve is closed. To release the vacuum inside the container, the user may manually push actuator 150 down with a finger against spring 152, and the lower end of body portion 156 then pushes valve 158 downward against spring 162. Atmospheric air from region 168 outside the lid or from vented air 126 in the upper lid interior then passes around the opened valve 158, into chamber 148 and through filter 144 and mesh screen 146 into container interior 166. In doing so, the atmospheric air is filtered, and any trapped particles at the lower end of the filter and screen tend to be cleaned off and expelled back into the container.

Instead of being manually operable, release actuator 150 may comprise an electrically actuated solenoid that is actuated either by the user directly or by the controller. In the embodiment where the container is used to marinate foods using automatic cycling, upon user actuation to release the vacuum the controller will preferably be reset to discontinue the cycling and return to its initial state.

Both manual and electrically-operated pressure release actuators may be incorporated into the container or lid by configuring release actuator 150 as a manual push button, and by adding an electrically operated actuator 200 connected by tube segment 108a to tube 108. A solenoid 202 within the actuator is operable by the controller 128 (FIG. 10) to depress valve 158a and permit outside atmospheric air to enter through opening 204 and around opened valve 158a into tube 108. The atmospheric pressure air then passes into chamber 148 and through filter 144 into the container, as previously described.

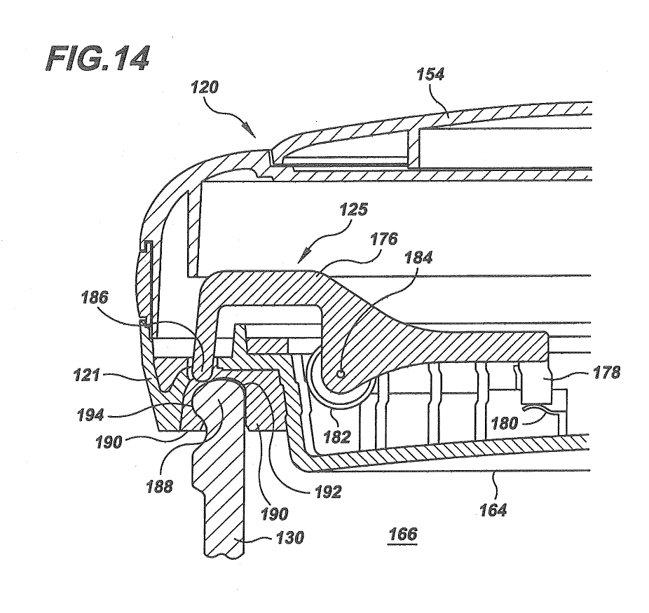

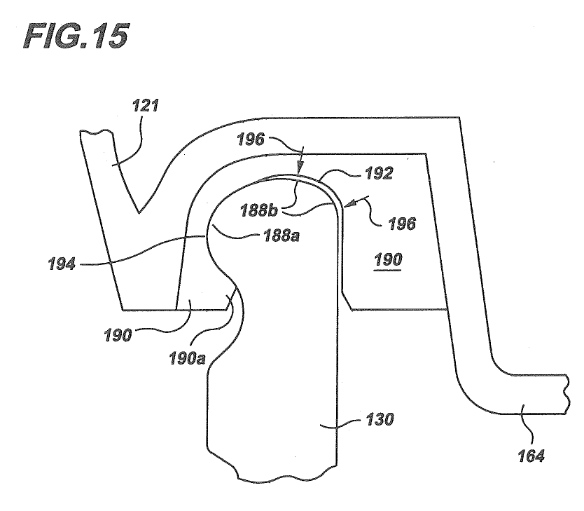

A preferred seal between lid 120 and container 130 is shown in FIGS. 14 and 15. A lip or rim 188 extends continuously around the entire open top of container 130, and includes an outwardly protruding portion 188a extending away from the container opening, and an upward and inward portion 188b on the lip end. Lip portions 188a, 188b smoothly curve in cross section into the outer and inner walls, respectively, of container 130. Lid 120 includes a flexible polymeric seal 190 extending continuously around the outside of the lower surface 164 to mate with container lip 188. Seal 190 is formed preferably by injection molding and includes a portion 194 configured to mate with outwardly protruding lip portion 188a and an integral portion 192 configured to mate with upper or inward lip portion 188b. The lower inwardly extending portion 190a of the seal has an inner diameter less than the outer diameter of the container outwardly extending lip portion 188a, so that the lid snaps onto the container. Lid seal portion 194 is formed to mate in a tight fit with protruding lip portion 188a to create an initial seal that is at least partially airtight when lid 120 is first placed onto container 130. This initial seal is sufficient to permit the partial evacuation of air from the container as pump 10 begins operation. Lid seal portion 192 preferably does not create a full hermetic seal when with container lip portion 188b when the lid is initially snapped onto the container. Instead, seal portion 192 is in at least partial contact with or spaced away slightly from container lip portion 188b prior to evacuation of the container, as shown in FIG. 15. As pump 10 begin operation, the air pumping capacity of pump 10 is sufficient to create an initial seal between seal portion 194 and to create a partial vacuum within container. With increasing air evacuation, and decreasing interior pressure in the container, lid seal portion 192 is squeezed down against container lip portion 188b by the downward force of lid 120, which is caused by the pressure differential between the partial vacuum inside the container and the atmospheric pressure outside the container. As seal portions 192 flex and deform into contact and engagement with container lip portion 188b, shown by the direction of arrows 196, a full hermetic seal is created between these portions 188b, 192 of the container lip and lid seal, respectively.

Lid seal 190 also includes an opening in a single location around the lid periphery between seal outer portion 194 and seal upper and inner portions 192. This opening permits an end 186 of lever 176 to contact the upper portion of container lip 188. Contact lever 176 is part of switch 125 which signals when the lid is in proper closed position over container 130. Lever 176 rotates around pivot 184 and is biases by coil spring 182 in a counterclockwise rotation, as shown in FIG. 14. As lever end 186 contacts container lip 188, it is forced in a clockwise direction to pivot so that the opposite end 178 of lever 176 contacts electrical contact 180, and signals to the controller (128 in FIG. 1) that the lid has closed the container, and that pump 10 is permitted to begin operation. As described previously, the controller may then automatically start pump 10 to evacuate the container. To prevent exhaustion of the pump battery or damage to the pump in the event that the container has an air leak (either in the seal or otherwise), the preferred microprocessor controller may also incorporate a timer to disengage and turn of the pump after a predetermined period of time has passed. This time period may be pre-programmed into the controller, or set by the user. In any event, the controller preferably disengages operation of the pump at the earlier of achieving the desired degree of vacuum in the container, as signaled by vacuum indicator (110, FIGS. 1 and 9, or 110a, FIGS. 11 and 12), or of expiration of the predetermined time period.

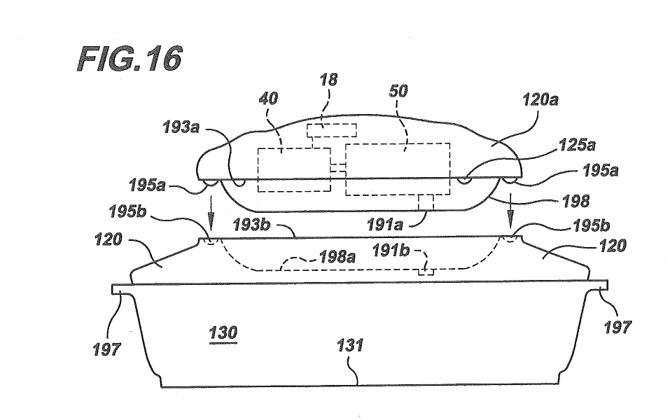

To remove and protect pump 10 when the lid 120 needs to be washed or otherwise cleaned, the pump may be made to be easily removable from the container lid. FIGS. 16-18 depict a preferred embodiment wherein motor 40, piston drive reciprocating member 50 and power supply 18 and other portions of pump 10 are disposed in a removable lid section 120a that includes inwardly extending finger grips 199 formed into the exterior of section 120a. The lower portion 198 of lid portion 120a, containing part of the pump works, extends below mating edge 193a and is configured to fit into depression opening 198a within mating edge 193b in lid 120. Removable lid section 120 includes latch members 195a on either end that engage corresponding latch openings 195b in container lid 120 to operably secure the mating edges 193a of upper lid portion 120a to the mating edges 193b of lid 120 when the former is lowered onto the latter in the direction shown by the arrows. Lid portion 120a also includes at least one mating member or opening 191a to connect the pump 10 air inlet and/or outlet to a corresponding inlet and/or outlet 191b on lid 120. Mating opening 191b is further connected to connecting tube 108 (FIG. 10) to permit evacuation or pressurization of the container. Except for the pump mating connection openings, lid 120 is airtight. The pump-containing lid portion 120a may also incorporate a contact switch 125a, with the same structure and function as switch 125 described previously, to signal to the controller when pump-containing upper lid portion 120a is in proper latched position on lid 120. Switch 125a may include a lever with an end extending from upper lid portion edge 193a that contacts mating edge 193b of lid 120 to signal that the pump-containing lid portion is secured to the lid, and that pump 10 is permitted to start operation, as described previously.

In normal operation, where pump-containing lid portion 120 is mated to lid 120, the user grasps finger grips 199 with one hand and handles 197 on container 130 with the other to secure or remove the lid with respect to the container. The user separately removes lid portion 120a containing pump 10 when lid 120 is to be cleaned by unlatching it from lid 120, and subsequently re-latching it back onto the lid after the lid cleaning is completed.

Thus, the present invention provides an improved vacuum or pressure food storage device that filters air entering or leaving the container; protects the pump motor and power supply from excessive use in the case of an air leak in the container; permits calibration of the pressure or vacuum sensor prior to assembly into the container; permits removal of the pump prior to cleaning the lid; permits better hermetic sealing of the lid to the container; and moves the food with respect to the marinade while evacuating air from the container. It is particularly useful for storing foods such as coffee under a vacuum, and for marinating foods using a cyclic vacuum and/or pressure environment resulting in faster and better infusion and saturation of the marinade into the food.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of marinating food comprising:
providing a container for the food;
providing a marinade in the container;
hermetically sealing the food in the container on a base in contact with the marinade;
evacuating air from the container to a desired degree of vacuum while simultaneously raising the base of the container to move the food with respect to the marinade;
maintaining the food in contact with the marinade under the vacuum for a desired time; and
releasing the hermetic seal to permit air to enter the container while simultaneously lowering the base of the container when the food is marinated to a desired degree.

2. The method of claim 1 wherein the container is provided with a flexible base, and wherein evacuating air from the container causes the base to raise as a result of pressure differential between the vacuum in the container and atmospheric air pressure outside the container, and wherein releasing the hermetic seal to permit air to enter the container causes the base to lower.

3. A method of storing food under a vacuum comprising:
providing a container for the food, the container having a filter for entry and exit of air into and out of the container;
hermetically sealing the food in the container;
evacuating air from the container to a desired degree of vacuum while simultaneously filtering air evacuated out of the container through the filter;
maintaining the food under the vacuum for a desired time; and
releasing the hermetic seal to permit air to enter the container while simultaneously filtering air entering into the container through the filter.

4. The method of claim 3 wherein food particles are trapped in the filter during evacuation of the air from the container, and wherein at least a portion of the food particles trapped in the filter are expelled therefrom during entry of the air into the container.

5. A vacuum food storage device comprising a container for storing food, the container being hermetically sealable and having a filter for entry and exit of air into and out of the container, the filter being adapted to filter air evacuated out of the container and air entering into the container therethrough.

6. The device of claim 5 wherein the filter is adapted to trap food particles in the filter during evacuation of the air from the container, and expel at least a portion of the food particles trapped in the filter during entry of the air into the container.

7. A method of storing food under a vacuum comprising:
providing a container for the food, the container including a lid to hermetically seal food in the container, a pump to evacuate air from the container, a switch engageable by contact of the pump to the lid, or by contact of the lid to the container, to permit operation of the pump to evacuate air from the container to a desire degree of vacuum, a sensor to disengage operation of the pump when a desired degree of vacuum is achieved in the container, and a timer to disengage operation of the pump after a predetermined time;
placing food in the container;
placing the pump on the lid, or the lid on the container, and engaging the switch;
operating the pump to evacuate air from the container; and
disengage operation of the pump at the earlier of: i) achieving a desired degree of vacuum in the container, or ii) expiration of the predetermined time by the timer.

8. The method of claim 7 wherein the pump is disposed in the lid and wherein the switch is adapted to commence operation of the pump upon contact of the lid with the container, and including commencing operation of the pump when the lid is placed on the container.

9. The method of claim 7 wherein the pump is separate from the lid and wherein the switch is adapted to commence operation of the pump upon contact of the pump with the lid, and including commencing operation of the pump when the pump is placed on the lid.

10. A vacuum food storage device comprising a container for the food, a lid to hermetically seal food in the container, a pump to evacuate air from the container, a switch engageable by contact of the pump to the lid, or by contact of the lid to the container, to permit operation of the pump to evacuate air from the container to a desire degree of vacuum, a sensor to disengage operation of the pump when a desired degree of vacuum is achieved in the container, and a timer to disengage operation of the pump after a predetermined time, whereby upon placing the pump on the lid, or the lid on the container, engaging the switch, and operating the pump to evacuate air from the container, operation of the pump is disengaged at the earlier of: i) achieving a desired degree of vacuum in the container, or ii) expiration of the predetermined time by the timer.

11. The device of claim 10 wherein the pump is disposed in the lid and wherein the switch is adapted to commence operation of the pump upon contact of the lid with the container, whereby operation of the pump is commenced when the lid is placed on the container.

12. The device of claim 10 wherein the pump is separate from the lid and wherein the switch is adapted to commence operation of the pump upon contact of the pump with the lid, whereby operation of the pump is commenced when the pump is placed on the lid.

13. A method of making a vacuum or pressure food storage device comprising:
providing a container for the food, a lid to hermetically seal food in the container, and a pump to evacuate air from the container;
providing, separately from the container, a sensor to disengage operation of the pump when a desired degree of vacuum or pressure is achieved in the container;
separately from the container, calibrating and setting in the sensor a predetermined degree of vacuum or pressure required to disengage operation of the pump; and
installing the sensor in the container during manufacture thereof to establish the predetermined degree of vacuum or pressure at which operation of the pump is disengaged.

14. The method of claim 13 wherein the pump is disposed in the lid, and including installing the sensor in the lid during manufacture of the container.

15. A vacuum or pressure food storage device comprising a container for the food, a lid to hermetically seal food in the container, a pump to evacuate air from the container, and a sensor to disengage operation of the pump when a desired degree of vacuum or pressure is achieved in the container, the sensor being separable from the container to calibrate and set the degree of vacuum or pressure required to disengage operation of the pump, whereby the sensor may be calibrated to a predetermined degree of vacuum or pressure apart from the container, and installed in the container during manufacture thereof to establish the predetermined degree of vacuum or pressure at which operation of the pump is disengaged.

16. The device of claim 15 wherein the pump is disposed in the lid, and whereby the sensor may be installed in the lid during manufacture of the container.

17. The device of claim 15 wherein the sensor comprises a flexible membrane with an electrically conductive first contact secured thereto, and an electrically conductive second contact adjustably spaced from the first contact.

18. A method of hermetically sealing a vacuum food storage device comprising:
providing a container for the food, the container having a lip around an opening therein, the lip having a first portion extending outwardly with respect to the container opening and a second portion extending upwardly and inwardly with respect to the container opening;
providing a lid securable to the container opening to hermetically seal food in the container, the lid including a seal having a first portion tightly engageable with the lip first portion when the lid is secured to the container opening to create an initial, partially airtight seal, and a second portion engageable with the lip second portion to create a hermetic seal as air is evacuated from the container;
securing the lid to the container lip and tightly engaging the first portion of the lid seal with the container lip first portion to create an initial seal; and
evacuating air from the container to cause the second portion of the lid seal to engage with the container lip second portion to create a hermetic seal between the lid and the container.

19. The method of claim 18 wherein upon securing the lid to the container lip and prior to evacuating air from the container, the second portion of the lid is not hermetically sealed to the container lip second portion.

20. A vacuum food storage device comprising a container for the food, the container having a lip around an opening therein, the lip having a first portion extending outwardly with respect to the container opening and a second portion extending upwardly and inwardly with respect to the container opening, and a lid securable to the container opening to hermetically seal food in the container, the lid including a seat having a first portion tightly engageable with the lip first portion when the lid is secured to the container opening to create an initial seal, and a second portion engageable with the with the lip second portion to create a hermetic seal as air is evacuated from the container.

21. A method of cleaning a vacuum or pressure food storage device comprising:
providing a container for the food, a lid to hermetically seal food in the container, an opening in an exterior surface of the lid for receiving a pump, and a vacuum or pressure pump to evacuate air from or inject air into the container, the pump being releasably mounted in the pump opening in the lid by a latch;
operating the latch and removing the pump from the lid;
cleaning the lid; and
thereafter reattaching the pump to the lid opening using the latch.

22. A vacuum or pressure food storage device comprising a container for the food, a lid to hermetically seal food in the container, an opening in an exterior surface of the lid for receiving a pump, and a vacuum or pressure pump to evacuate air from or inject air into the container, the pump being releasably mounted in the pump opening in the lid by a latch, whereby the pump may be removed by hand by a user from the pump opening prior to cleaning the lid.
